(19) United States
(12) Patent Application Publication
(10) Pub. No.: US 2013/0336718 A1
(43) Pub. Date: Dec. 19, 2013

(54) PILLAR FOR ASSEMBLY TYPE FURNITURE

(71) Applicant: Jae won JEON, Chuncheon-si (KR)

(72) Inventor: Jae won JEON, Chuncheon-si (KR)

(21) Appl. No.: 13/954,676

(22) Filed: Jul. 30, 2013

Related U.S. Application Data
(63) Continuation-in-part of application No. PCT/KR2012/000704, filed on Jan. 30, 2012.

(30) Foreign Application Priority Data
Jan. 31, 2011 (KR) 10-2011-0009197

(51) Int. Cl. F16B 12/44

(52) U.S. Cl. CPC F16B 12/44
USPC 403/359.1; 403/361

(57) ABSTRACT

There is provided a pillar for assembly type furniture comprising: a first pillar that has a first top to be brought in contact with the ceiling and a first bottom positioned at the opposite end to the first top; a second pillar that has a second top wider than the first bottom and a second bottom positioned at the opposite end to the second top, and has a first coupling hole in which the first pillar is inserted as much as a predetermined length, including the first bottom, longitudinally from the second top; a third pillar that is longitudinally combined with the second pillar and has a third top and a third bottom positioned at the opposite end to the third top to be brought in contact with the floor; a coupling mechanism keeping the second pillar and the third pillar longitudinally combined; and an elastic member.

### CROSS-REFERENCE TO RELATED APPLICATIONS

This application is a Continuation-in-Part of PCT/KR2012/000704 filed 30 Jan. 2012 which claims priority of Korean Patent Application No. KR 1 0-201 1-00091 97 filed on 31 Jan. 2011, in the Korean Intellectual Property Office, the disclosure of which is incorporated herein by references.

### FIELD

The present disclosure relates to a pillar for assembly type furniture, particularly a pillar for assembly type furniture of which both ends are fixed in close contact between a ceiling and a floor.

### BACKGROUND

Recently, assembly type furniture that consumers manufacture in person by assembling the parts has been increasing popular. The reason of the popularity of the assembly type furniture may be because the consumers can save the money for the furniture by manufacturing them in person, the furniture can be easily moved to the installation place due to free assembly and disassembly of the parts, and the consumers can feel a sense of achievement from manufacturing by themselves.

For this reason, most of the assembly type furniture was the products such as hangers and simple cabinets in the earlier stage, but they are gradually expanding to the products such as beds and clothes chests.

The materials were usually iron and plastic in the past, but wood has been used, as the environment rises as an important issue.

According to this tendency, iron, the material of the hangers, will be naturally displaced with wood.

However, the hangers need a pillar installed in close contact with a ceiling and a floor. Wooden pillars need a different structure from iron pillars of the related art because they are not easy to machine, unlike the iron pillars, such that they are difficult to make into commercial products.

Further, the pillars for assembly type furniture that are made of wood and fixed in close contact with a ceiling and a floor are available for clothes chests and partitions, such that the necessity of developing a wooden pillar that is easy to machine and assemble more and more increases.

### SUMMARY

The present disclosure provides a wooden pillar for assembly type furniture which reduces the cost of parts and can be easily assembled by consumers.

Also, the present disclosure provides a pillar for assembly type furniture which has an excellent external appearance.

Also, the present invention provides a pillar for assembly type furniture which is made of wood and can provide convenience for installation and high stability with improved close contact feature with a ceiling and a floor.

An embodiment of the present disclosure provides a pillar for assembly type furniture of which both ends are fixed in contact with a ceiling and a floor, and which includes: a first pillar that has a first top to be brought in contact with the ceiling and a first bottom positioned at the opposite end to the first top; a second pillar that has a second top wider than the first bottom and a second bottom positioned at the opposite end to the second top, and has a first coupling hole in which the first pillar is inserted as much as a predetermined length, including the first bottom, longitudinally from the second top; a third pillar that is longitudinally combined with the second pillar and has a third top and a third bottom positioned at the opposite end to the third top to be brought in contact with the floor; a coupling mechanism keeping the second pillar and the third pillar longitudinally combined; and an elastic member that is disposed in a first coupling hole and applies a restoring force to the first pillar inserted in the first coupling hole in the opposite direction to the insertion direction of the first pillar.

The second bottom may be smaller in area than the second top, and the coupling mechanism may be a second coupling hole where a portion of the second pillar, including the second bottom, is inserted at a predetermined depth in the longitudinal direction of the third pillar from the third top.

The second pillar may have a second insertion that is inserted in the second coupling hole, which is a portion of the second pillar, including the second bottom, and the second coupling hole has a predetermined length from the second bottom and the same sectional area as the second bottom, and the second coupling hole may have a shape corresponding to the second insertion.

The second pillar may include: a second center pillar having the same cross-section as that of the first insertion and a predetermined length; and second external plates disposed around the second pillar such that the circumference of the second center pillar is partially exposed, the first coupling hole may be defined by the top of the center pillar and the inner side of the second external plate that is not combined with the center pillar, and the first insertion may be defined as the portion where the second external plate is not disposed, in the external sides of the center pillar.

The coupling mechanism may include: coupling grooves formed longitudinally on the external sides of the second pillar and the third pillar and connected with each other; and coupling members fitted in the coupling grooves with one end and the other end fixed to the second pillar and the third pillar, respectively.

The fastening member may be made of iron where a magnet can be attached.

The fastening member further may have a plurality of fastening holes arranged longitudinally at predetermined intervals.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing a pillar for assembly type furniture, which has been assembled, according to a first embodiment of the present disclosure;

FIG. 2 is a view showing the pillar of FIG. 1 which has been disassembled;

FIGS. 3 and 4 are views showing a pillar for assembly type furniture according to a second embodiment of the present disclosure;

FIG. 5 is a view showing a pillar for assembly type furniture according to a third embodiment of the present disclosure;

FIG. 6 is a view showing an example of a piece of assembly type furniture equipped with the pillar for assembly type furniture shown in FIG. 5;

FIG. 7 is a view showing a pillar for assembly type furniture according to a fourth embodiment of the present disclosure;

FIGS. 8 and 9 are views showing modifications of that shown in FIG. 7;

FIG. 10 is a view showing an example of a piece of assembly type furniture using the pillar for assembly type furniture of FIG. 7;

FIG. 11 is a view showing an example of the cross-section taken along line A-A in FIG. 10; and

FIG. 12 is a view showing another example of the cross-section taken along line A-A in FIG. 10.

### DETAILED DESCRIPTION

Hereinafter, various embodiments of a pillar for assembly type furniture according to the present disclosure will be described with reference to the accompanying drawings.

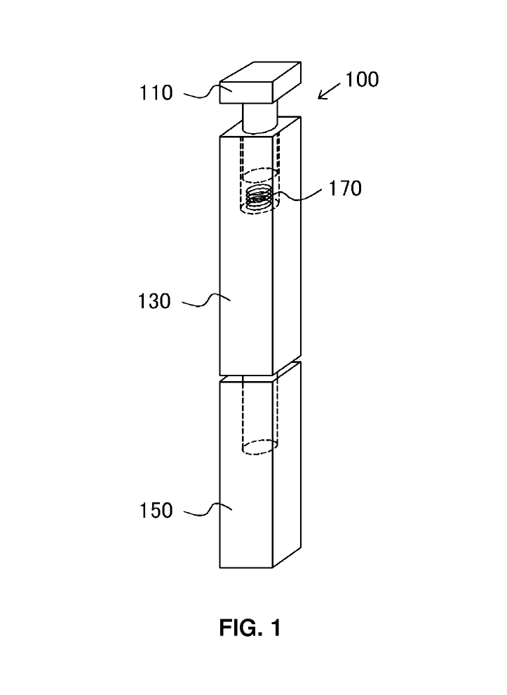

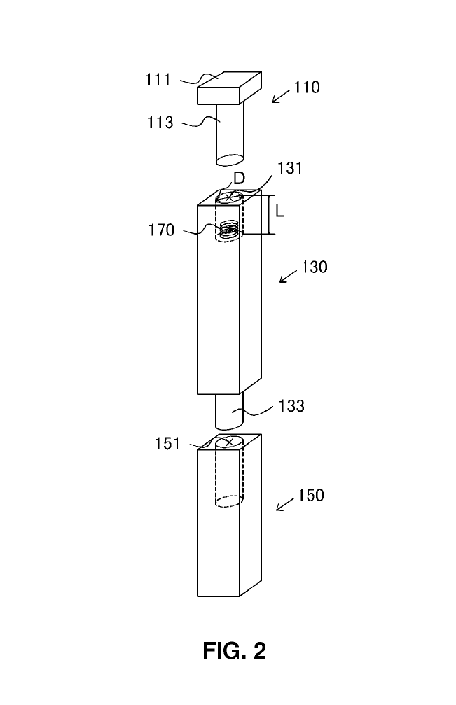

FIG. 1 is a view showing a pillar for assembly type furniture, which has been assembled, according to a first embodiment of the present disclosure and FIG. 2 is a view showing the pillar of FIG. 1 which has been disassembled.

Referring to FIGS. 1 and 2, a pillar 100 for assembly type furniture according to the embodiment has both ends that are fixed in close contact with a ceiling and a floor, and is composed of three pieces of pillars 110, 130, and 150 which are coupled together.

The three pillars 110, 130, and 150 are the upper pillar 110 that is brought in contact with a ceiling, the lower pillar 150 that is brought in contact with a floor, and an intermediate pillar 130 between them.

For assembly type furniture, the parts are transported to a consumer and the consumer assembles the parts, in which it is possible to prevent problems in transportation due to a large length by cutting the pillar 100 for assembly type furniture which is relatively long into the three pillars 110, 130, and 150.

Accordingly, it is possible to further reduce problems in transportation by making the intermediate pillar 130 into a plurality of pieces.

However, considering that the more the intermediate pillars 130, the more the installation stability of the pillar 100 for assembly type furniture may decrease, it is preferable to adjust the number of the intermediate pillars 130, that is, the length of the intermediate pillars 130.

The upper pillar 110 has one end 111 that is brought in contact with a ceiling and a first insertion 113 coupled to the intermediate pillar 130.

The intermediate pillar 130 has a first coupling hole 131 where the first insertion 113 is inserted, at one end, and a second insertion 133 coupled to the lower pillar 150 at the other end.

The lower pillar 150 has a second coupling hole 151 where the second insertion 133 is inserted, at one end, and has the other end that is brought in contact with a floor.

An elastic member 170 applying a restoring force to the first insertion 113 is disposed in the first coupling hole 131.

The restoring force exerted in the direction opposite to the insertion direction of the first insertion 113.

The elastic member 170 may be disposed in the second coupling hole 151.

In detail, as long as the elastic member 170 is arranged to apply a restoring force in the longitudinal direction of the pillar 100 for assembly type furniture, it may be disposed in the first coupling hole or the second coupling hole.

Since the restoring force of the elastic member 170 is directly linked to the installation stability of the pillar 100 for assembly type furniture, it is preferable to include a coil spring having relatively constant stiffness regardless of displacement.

The first insertion 113 and the first coupling hole 131 have corresponding shapes.

In order to prevent the first insertion 113 from moving in the cross-sectional direction, after coupling them, it is required to adjust the tolerance of the first insertion 113 and the first coupling hole 131 to a predetermined level or less.

The first insertion 113 may be a bar with a constant cross-section.

The cross-section may be a circle and a polygon, or may be a gear shape; there would be difficulty in manufacturing though.

For a polygon, a star shape, and a gear shape, it is possible to prevent relative rotation between the upper pillar 110 and the intermediate pillar 130 with the first insertion 113 in the first coupling hole 131.

The first insertion 113 may have a wedge shape of which the cross-section become smaller toward the other end of the upper pillar 110.

In this case, the first coupling hole 131 obviously has a wedge shape.

For a wedge shape, as a portion of the wedge is inserted inside the coil spring, the position of the coil spring can be firmly fixed in comparison to the bar shape.

The second insertion 133 and the second coupling hole 151 are almost the same as the first insertion 113 and the first coupling hole 131 described above, and thus the description is replaced with that described above.

The upper pillar 110, the intermediate pillar 130, and the lower pillar 150 are wooden MDFs (Medium Density Fiberboard).

Further, it is possible to further improve the stability of the assembled pillar by forming thickness-directional holes that fit together when the intermediate pillar 130 and the lower pillar 150 are combined, in the second insertion 133 of the intermediate pillar 130 and the second coupling hole 151 of the lower pillar 150, and by putting a screw or a pin into the thickness-directional holes fitting together, with the intermediate pillar 130 and the lower pillar 150 combined. Satisfaction with the product can be further improved by preparing a wooden pin.

The first and second coupling holes 131 and 151 may be formed by drilling.

Since the first and second coupling holes 131 and 151 are longitudinally formed in the intermediate pillar 130 and the lower pillar 150, there is a technical restriction in making the first and second coupling hole 131 and 151 deep.

Accordingly, it is preferable that the depth L of the first coupling hole 131 be the sum of the diameter D of the first coupling hole 131 and the length of the elastic member 170.

For example, when the diameter D of the first coupling hole 131 is 3 cm and the elastic member 170 is 10 cm long under a balance state, it is preferable that the depth L of the first coupling hole 131 be 13 cm.

Extremely, even if the depth L of the first coupling hole 131 and the length of the elastic member 170 under the balance state are the same, assembling is possible by contraction of the elastic member 170 in the combination process, but the assembling is easier by providing a tolerance in length as much as the diameter D of the first coupling hole 131. Therefore, satisfaction with the product of consumers can be further improved.

Further, it is possible to adjust the length of the pillar 100 for assembly type furniture according to the embodiment by disposing a height control plate with the same area as that of the first coupling hole 131, over or under the elastic member 170.

A plurality of height control plates may be provided and the length is preferably about 1 cm in the length direction of the pillar 100.

Accordingly, it is possible to cope with different distances between ceilings and floors according to the place where the pillar 100 is installed.

Further, a rubber plate with a pattern on the surface may be disposed on the top of the upper pillar 110 to be brought in close contact with a ceiling and the bottom of the lower pillar 150 to be brought in close contact with a floor in order to improve the friction force on the ceiling and the floor.

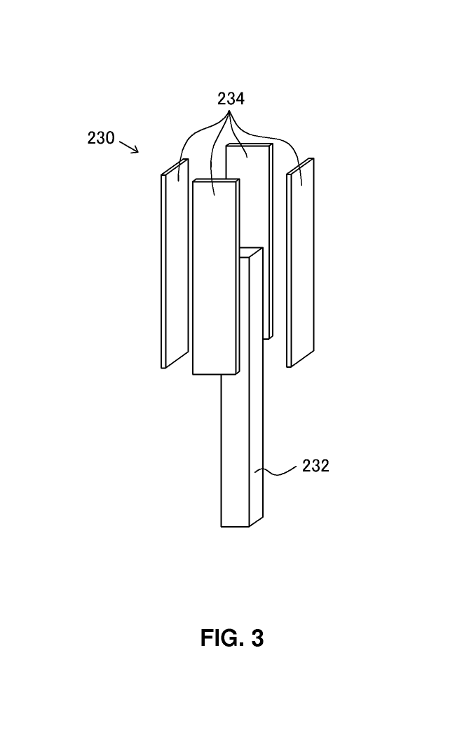

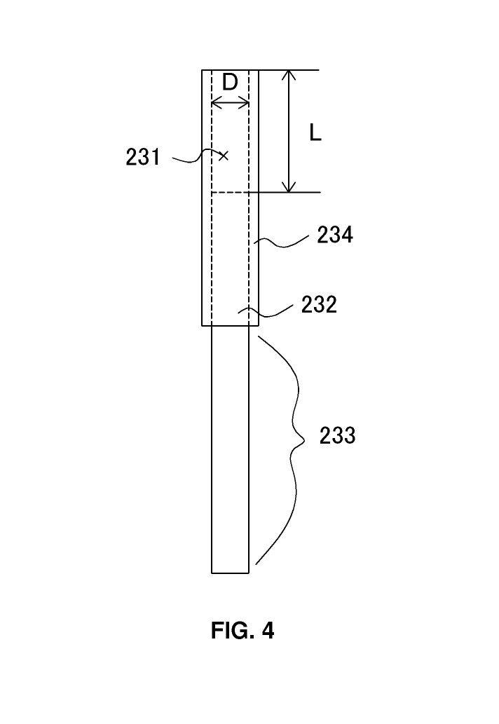

FIGS. 3 and 4 are views showing a pillar for assembly type furniture according to a second embodiment of the present disclosure.

Referring to FIGS. 3 and 4, in a pillar for assembly type furniture according to the embodiment, an intermediate pillar 230 is composed of a center pillar 232 having a predetermined length and external plates 234 disposed on all of the sides of the center pillar 232 such that the sides of the center pillar 232 are partially exposed.

In this configuration, a first coupling hole 231 is defined by the top of the center pillar 232 and the inner side of the external plate 234 that is not combined with the center pillar and the portion where the external plate 234 is not disposed, in the external sides of the center pillar 232, is defined as a second insertion 233.

The center pillar 232 and the external plates 234 may be combined by screws or an adhesive.

Accordingly, since the first coupling hole 231 can be formed without drilling, it is free to adjust the depth of the first coupling hole 231 and it is also possible to freely make the shape of the cross-section of the center pillar 232.

However, it is preferable that the depth L of the first coupling hole 231 be the sum of the diameter D of the first coupling hole 231 and the length of an elastic member, as described above, for stable combination and easy assembly.

For example, when the diameter D of the first coupling hole 231 is 3 cm and the elastic member is 10 cm long under a balance state, it is preferable that the depth L of the first coupling hole 231 be 13 cm.

In case that the shape of the first coupling hole 231 is a polygon, not a circle, the diameter D of the first coupling hole 231 means the converted diameter with the area of the first coupling hole 231.

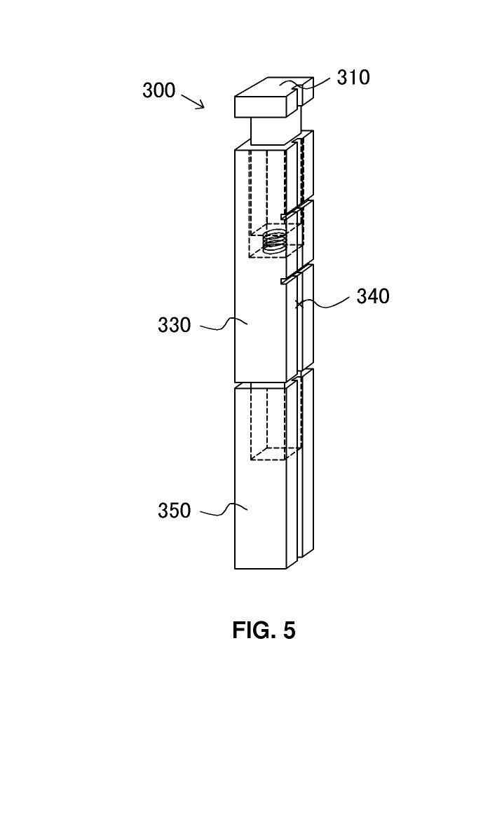

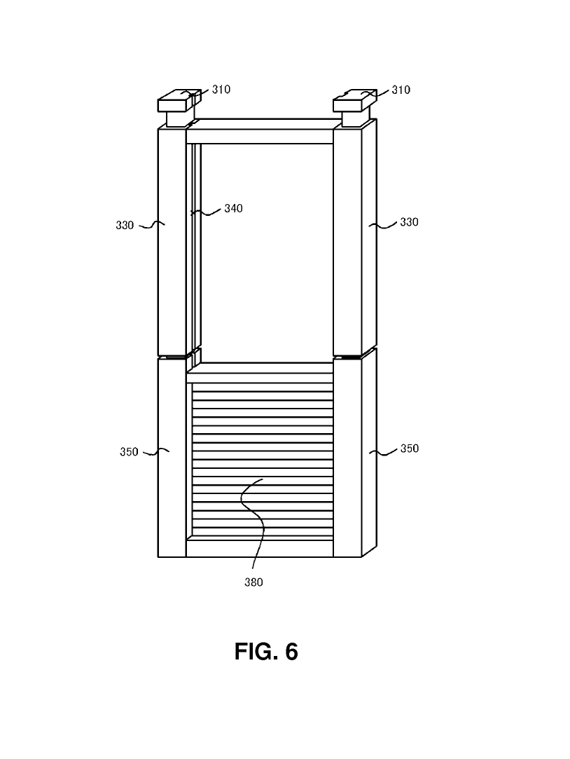

FIG. 5 is a view showing a pillar for assembly type furniture according to a third embodiment of the present disclosure and FIG. 6 is a view showing an example of a piece of assembly type furniture equipped with the pillar for assembly type furniture shown in FIG. 5.

Referring to FIG. 5, the pillar is almost the same as the pillar 100 for assembly type furniture described with reference to FIG. 3, but there is a difference in that a fitting groove 340 is formed on the pillar 300 for assembly type furniture.

The fitting groove 340 may be formed in the longitudinal direction and the thickness direction of the pillar 300 for assembly type furniture.

The fitting groove 340 is provided for manufacturing a piece of assembly type furniture by fitting another part to the pillar 300 for assembly type furniture and FIG. 6 is a view for illustrating an example of the fitting groove.

Referring to FIG. 6, by a plurality of plates 380 are fitted and stacked into the fitting grooves 340, with two pillars 300 for assembly type furniture which have the fitting groove 340 facing and fixed to each other, the assembly can function as a partition dividing an indoor space.

Further, it is possible to further improve the esthetic external appearance by disposing a curtain between the two pillars 300 for assembly type furniture.

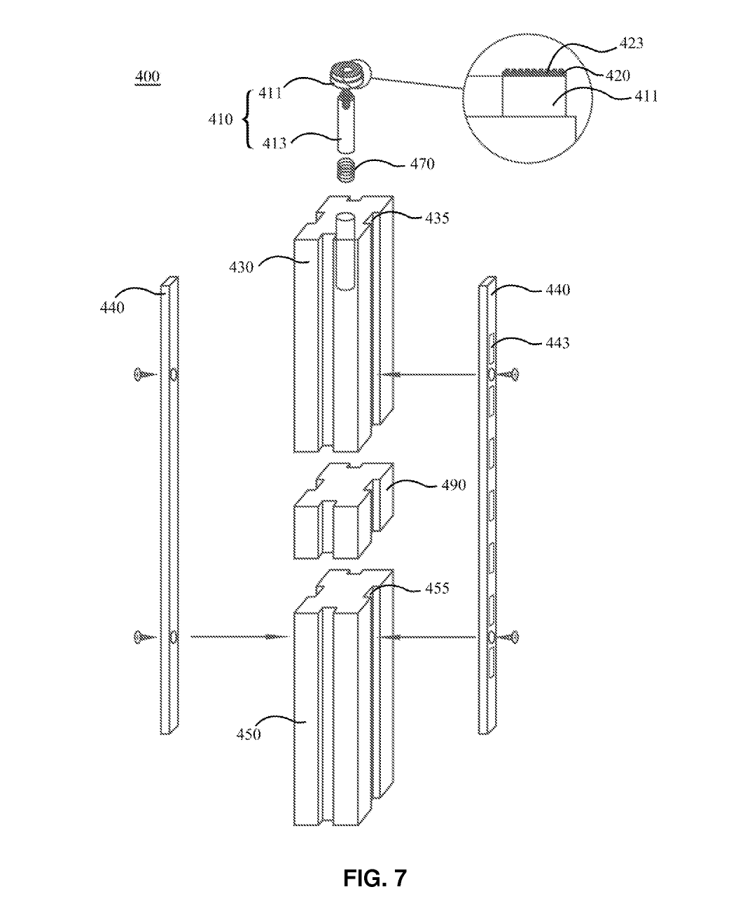

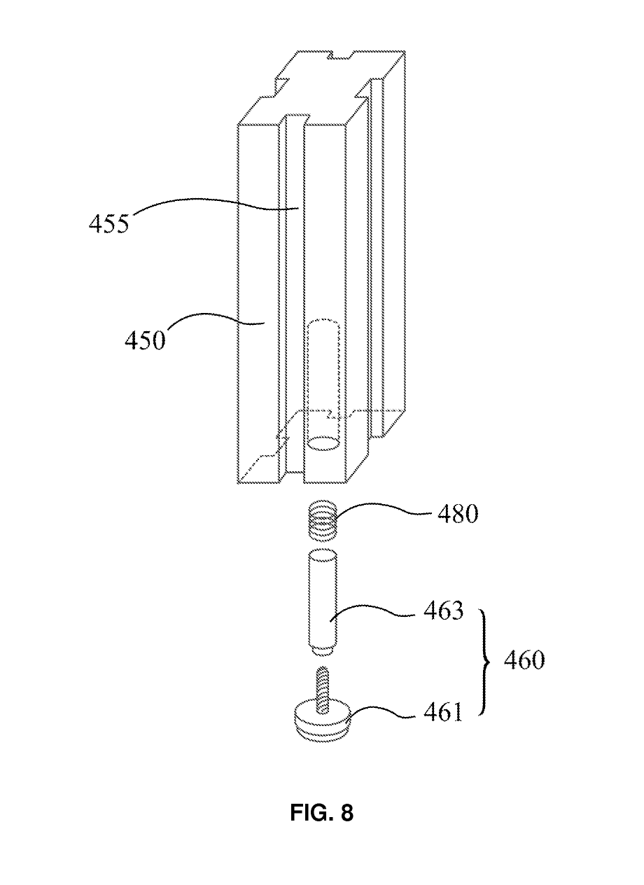

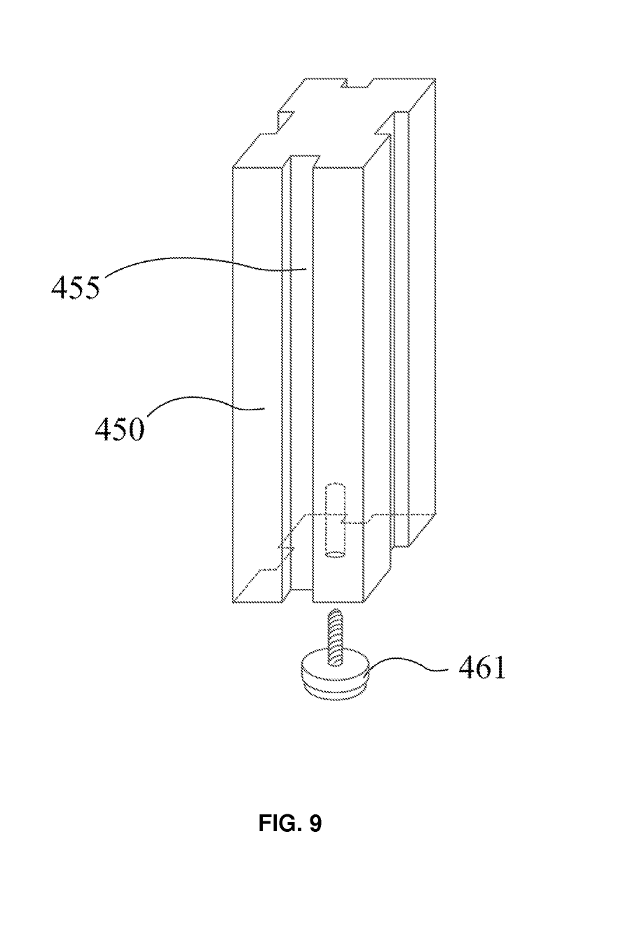

FIG. 7 is a view showing a pillar for assembly type furniture according to a fourth embodiment of the present invention and FIGS. 8 and 9 are views showing modifications of that shown in FIG. 7.

Referring to FIG. 7, the pillar 400 for assembly type furniture according to the embodiment is almost the same in other configurations as those configurations described above, except for a difference only in the way of combining an intermediate pillar 430 and a lower pillar 450. Accordingly, the description for the repeated configurations is replaced with those described above.

In the embodiment, the intermediate pillar 430 and the lower pillar 450 have coupling grooves 435 and 455 formed in the longitudinal direction on them, respectively.

The coupling groove 435 on the intermediate pillar 430 and the coupling groove 455 on the lower pillar 450 are connected with each other, when the intermediate pillar 430 and the lower pillar 450 are combined.

Further, the pillar 400 for assembly type furniture according to the embodiment includes fastening members 440 that are fitted in the coupling grooves 435 and 455.

One side and the other side of each of the fastening members 440 are fixed to the intermediate pillar 430 and the lower pillar 450, respectively, such that the intermediate pillar 430 and the lower pillar 450 are connected with each other.

It is preferable that the fastening members 440 be made of iron where a magnet may be attached.

It is preferable for the fastening member 440 have a plurality of fastening holes 443 longitudinally arranged at predetermined intervals. In this configuration, accessories such as a shelf may be fitted in the fastening holes 443.

The fastening members 440 may be fixed to the intermediate pillar 430 and the lower pillar 450 such that predetermined gap is defined between the intermediate pillar 430 and the lower pillar 450. According to this configuration, it is possible to cope with an increase in height from the floor to the ceiling of the place where the pillar 400 for assembly type furniture according to the embodiment is installed. In this configuration, it is preferable to further provide a fitting member 490 that is fitted in the gap to fill the gap between the intermediate pillar 430 and the lower pillar 450, in contact with the intermediate pillar 430 and the lower pillar 450. Deterioration of the external appearance due to the gap can be prevented.

On the other hand, an anti-sliding member 420 that is a plate may be disposed on the top of the upper pillar 410, that is, the side to come in contact with a ceiling, or the bottom of the lower pillar 450, that is, the side to come in contact with a floor, in order to increase the friction against the ceiling or the floor. The anti-sliding member 420 may be disposed on both of the sides.

It is preferable that the anti-sliding member 420 have anti-sliding projections 423. In particular, the anti-sliding projections 423 may need to be coaxial circles for effective prevention of sliding. Further, it is preferable that the anti-sliding member 420 be made of rubber.

In the embodiment, it is preferable that the upper pillar 410 be formed by thread-fastening of the insertion 413 and a ceiling contact portion 411 including the side coming in contact with a ceiling. Accordingly, the length of the upper pillar 410 can increase and decrease, and it is possible to sufficiently cope with changes in height between the ceiling and the floor of the places where the pillar for assembly type furniture of the present disclosure is installed.

In the same way of fitting the upper pillar 410 into the intermediate pillar 430, a height control pillar 460, which is another pillar, may be fitted into the bottom of the lower pillar 450, as shown in FIG. 8, in which it is preferable that the height control pillar 460 to be fitted in the bottom of the lower pillar 450 is composed of a floor contact portion 461 and an insertion 463, which are thread-fastened, in the same way of the upper pillar 410, and the length can be adjusted. Similarly, as shown in FIG. 9, the floor contact portion 461 is directly thread-fastened on the bottom of the lower pillar 450, and thus the height may be controlled.

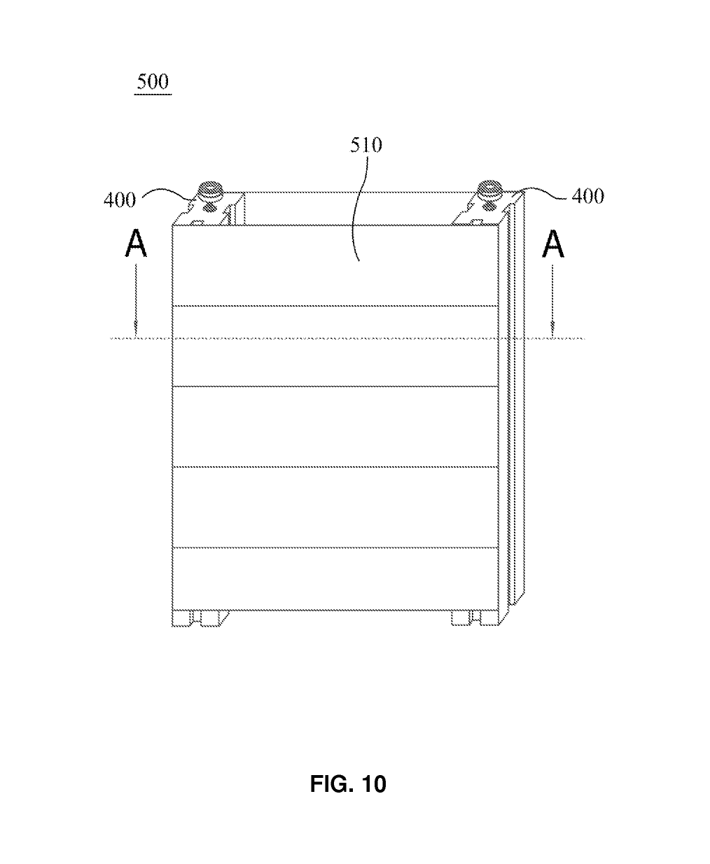

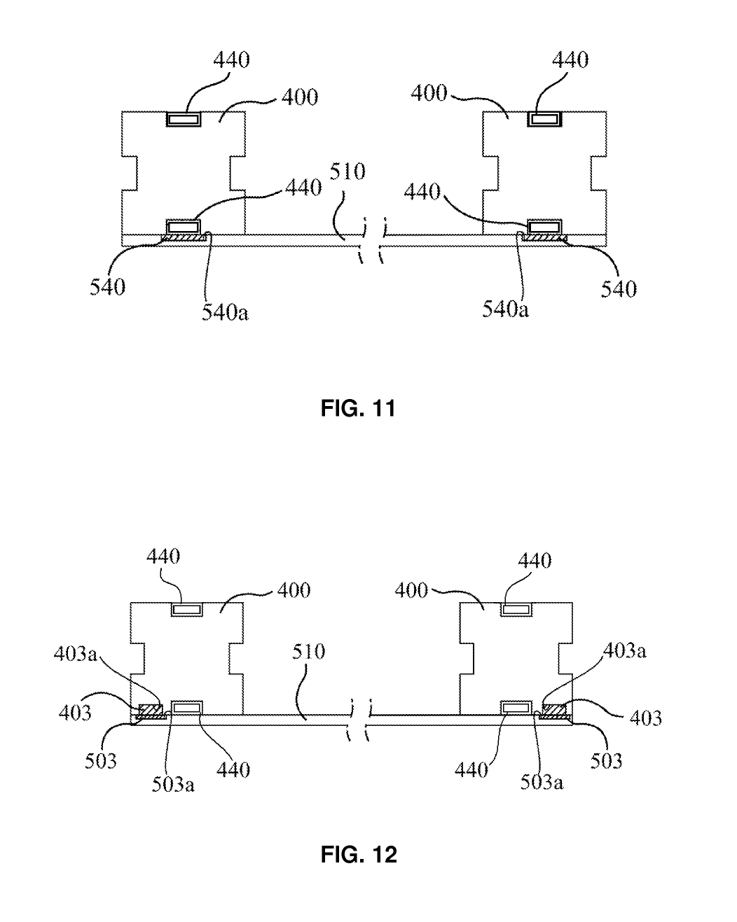

FIG. 10 is a view showing an example of a piece of assembly type furniture using the pillar for assembly type furniture of FIG. 7, FIG. 11 is a view showing an example of the cross-section taken along line A-A in FIG. 10, and FIG. 12 is a view showing another example of the cross-section taken along line A-A in FIG. 10.

Referring to FIG. 10, a piece of assembly type furniture 500 may include two pillars 400 for assembly type furniture and a plurality of plates 510 fixed to the pillars and forming walls. The plates 510 are combined with and fixed to the two pillars 400 for assembly type furniture, at both sides, in which they may be selectively and detachably combined by a magnet or Velcro, or may be fixed by screws or pieces.

Referring to FIGS. 11 and 12, when the plates 510 are combined with the pillars 400 for assembly type furniture by magnets 540 or Velcro 403 and 503, it is preferable to form receiving grooves 540a, 403a, and 503a that can receive the magnets or the Velcro on the combined sides between the pillars 400 for assembly type furniture and the plates 510 to preclude a gap between the pillars 400 for assembly type furniture and the plates 510 due to the thickness of the magnets 540 or the Velcro 403 and 503.

As set forth above, according to a pillar for assembly type furniture of the present disclosure, since the pillar is brought in close contact with a ceiling and a floor by the returning force from an elastic member, it is possible to remove the inconvenience of adjusting the length of the pillar on purpose for the close contact and then fixing it.

According to a pillar for assembly type furniture of the present disclosure, since a pillar for assembly type furniture which is made of wood or a material having the texture of wood with a simple structure, it is convenient to manufacture the parts and a consumer can conveniently assemble the parts, and a pillar with an excellent external appearance in comparison to metallic pillars is provided.

Various examples of a pillar for assembly type furniture according to the present invention were described above. The embodiments are exemplified for achieving the present invention, and the scope of the present invention is not limited to the embodiments and should be expanded to those described claims and the equivalents.

What is claimed is:

1. A pillar for assembly type furniture of which both ends are fixed in contact with a ceiling and a floor, the pillar comprising:
a first pillar that has a first top to be brought in contact with the ceiling and a first bottom positioned at the opposite end to the first top;
a second pillar that has a second top wider than the first bottom and a second bottom positioned at the opposite end to the second top, and has a first coupling hole in which the first pillar is inserted as much as a predetermined length, including the first bottom, longitudinally from the second top;
a third pillar that is longitudinally combined with the second pillar and has a third top and a third bottom positioned at the opposite end to the third top to be brought in contact with the floor;
a coupling mechanism keeping the second pillar and the third pillar longitudinally combined; and
an elastic member that is disposed in a first coupling hole and applies a restoring force to the first pillar inserted in the first coupling hole in the opposite direction to the insertion direction of the first pillar.

2. The pillar of claim 1, wherein the first pillar has a first insertion that is inserted in the first coupling hole and is a portion of the first pillar which has a predetermined length and the same area as the first bottom, and
the first coupling hole has a shape corresponding to the first insertion and is shorter than the first insertion.

3. The pillar of claim 1, wherein the elastic member is a coil spring on the bottom in the first coupling hole.

4. The pillar of claim 2, wherein the second bottom is smaller in area than the second top, and
the coupling mechanism is a second coupling hole where a portion of the second pillar, including the second bottom, is inserted at a predetermined depth in the longitudinal direction of the third pillar from the third top.

5. The pillar of claim 4, further comprising an additional elastic member disposed in the second coupling hole and applying a restoring force to the second pillar in the opposite direction to the insertion direction of the second pillar inserted in the second coupling hole.

6. The pillar of claim 4, wherein the second pillar has a second insertion that is inserted in the second coupling hole is a portion of the second pillar which has a predetermined length and the same area as the second bottom, and
the second coupling hole has a shape corresponding to the second insertion.

7. The pillar of claim 2, wherein the second pillar includes:
a second center pillar having the same cross-section as that of the first insertion and a predetermined length; and
second external plates disposed around the second pillar such that the circumference of the second center pillar is partially exposed,
the first coupling hole is defined by the top of the second center pillar and the inner side of the second external plate that is not combined with the second center pillar, and
the first insertion is defined as the portion where the second external plate is not disposed, in the external sides of the second center pillar.

8. The pillar of claim 6, wherein the third pillar includes:
a third center pillar having the same cross-section as that of the second insertion and a predetermined length; and
third external plates disposed around the third center pillar such that the circumference of the third center pillar is not exposed, and
the second coupling hole is defined by the top of the third center pillar and the inner side of the third external plate that is not combined with the third center pillar.

9. The pillar of claim 1, wherein the depth L of the first coupling hole is the sum of the length one or more times the diameter D corresponding to the cross-sectional area of the first coupling hole and the length of the elastic member.

10. The pillar of claim 1, wherein a plurality of the second pillars are provided and combined with each other and the first pillar and the third pillar are coupled to the tops and the bottoms of the second pillars.

11. The pillar of claim 1, wherein the second pillar and the third pillar are any one of wooden MDFs (Medium Density Fiberboard) and metallic members having the texture of wood.

12. The pillar of claim 2, wherein the coupling mechanism includes:
coupling grooves formed longitudinally on the external sides of the second pillar and the third pillar and connected with each other; and
fastening members fitted in the coupling grooves with one end and the other end fixed to the second pillar and the third pillar, respectively.

13. The pillar of claim 12, wherein the fastening member is made of iron where a magnet can be attached.

14. The pillar of claim 13, wherein the fastening member further has a plurality of fastening holes arranged longitudinally at predetermined intervals.

15. The pillar of claim 12, wherein the fastening members are fixed to the second pillar and the third pillar such that a gap is defined between the second pillar and the third pillar, and
the pillar further includes a fitting member fitted in the gap between the second pillar and the third pillar in contact with the second pillar and the third pillar.

16. The pillar of claim 1, further comprising an anti-sliding member having a plate shape disposed on the first top or the third bottom and having anti-sliding projections on the side to come in contact with the ceiling or the bottom.

17. The pillar of claim 16, wherein the anti-sliding member is a rubber member, and
the anti-sliding projections are coaxially arranged.

18. The pillar of claim 2, wherein the first pillar has the insertion and a ceiling contact portion including the first top, and
the insertion and the ceiling contact portion are thread-fastened so that the length of the first pillar is changed.

19. Assembly type furniture comprising the pillar of claim 1, a ceiling and a floor.
